(19) United States
(12) Patent Application Publication
(10) Pub. No.: US 2026/0087870 A1
(43) Pub. Date: Mar. 26, 2026

(54) LIGHTING MODULES WITH LENTICULAR SCREENS

(71) Applicant: Aristocrat Technologies, Inc., Las Vegas, NV (US)

(72) Inventors: Bhaskara Reddy Gaddam, Las Vegas, NV (US); Richard Walkup, II, Las Vegas, NV (US); Rolland Steil, Las Vegas, NV (US); James Connell, Las Vegas, NV (US); Kiran Dundaraddi, Las Vegas, NV (US)

(21) Appl. No.: 18/893,687

(22) Filed: Sep. 23, 2024

(51) Int. Cl. G07F 17/32; F21V 5/00; F21V 23/00; G07F 17/34

(52) U.S. Cl. CPC G07F 17/3211; F21V 5/007; F21V 23/003; G07F 17/3216; G07F 17/34

(57) ABSTRACT

Lighting modules with lenticular screens. The lenticular screens are supported so as to be offset from light sources within the lighting module, thereby acting as a directional diffuser that, depending on the orientation of the lenticules of the lenticular screen, may act to spread the light out in patterns having a clear directionality. The light sources may be controlled to turn on and off, or change color, in various ways to generate the appearance of movement.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome and symbols are then selected which correspond to that outcome. Notably, some games may include an element of skill on the part of the player and are therefore not entirely random.

Electronic gaming machines often feature extensive assortments of audiovisual devices that are used during game play, award payout, and during “attract” modes. The present disclosure is directed towards new implementations of lighting modules that may be suitable for use in such electronic gaming machines—although it will be understood that such lighting modules may also be used in any device or system in which the lighting effects produced by such modules may be desired.

### SUMMARY

Details of one or more implementations of the subject matter described in this specification are set forth in the accompanying drawings and the description below. Other features, aspects, and advantages will become apparent from the description, the drawings, and the claims.

In some implementations, an apparatus may be provided that includes a first lenticular screen having a plurality of first lenticules extending along corresponding first paths, a plurality of light sources, and a housing that supports the first lenticular screen relative to the light sources. The lenticular screen may be separated from the light sources by at least a first distance that is at least 0.25 inches.

In some implementations, the light sources may be arranged along one or more second paths, and the light sources arranged along each second path may be arranged along that second path in an evenly spaced manner.

In some such implementations, the apparatus may further include a controller that is configured to selectively control subsets of the light sources to cause progressive changes in one or both of color of light emitted by the light sources in each subset of the light sources and magnitude of light emitted by the light sources in each subset of the light sources along the second path or second paths.

In some such implementations, the controller may be, or may be in communication with, an electronic gaming machine controller.

In some implementations, there may be multiple second paths, e.g., two or three second paths.

In some implementations, the second paths may be identically shaped and oriented and spaced apart from one another along an axis.

In some implementations, the second paths may each define a plane and the axis may be perpendicular to the plane.

In some implementations, each first path may be at a corresponding first oblique angle relative to a first edge of the first lenticular screen.

In some implementations, the first oblique angles may be between 30° and 60°, e.g., between 40° and 50°, e.g., 45°±2°.

In some implementations, each first path may be perpendicular to a first edge of the first lenticular screen.

In some implementations, each first path may be parallel to a first edge of the first lenticular screen.

In some implementations, the apparatus may further include a first transparent layer, wherein the housing supports the first transparent layer such that the first lenticular screen is between the first transparent layer and the plurality of light sources.

In some implementations, the apparatus may further include a second transparent layer and the housing may support the second transparent layer such that the first lenticular screen is between the first transparent layer and the second transparent layer.

In some implementations, at least one of the first transparent layer and the second transparent layer may support the first lenticular screen, and the housing may support the first lenticular screen by supporting the first transparent layer and the second transparent layer.

In some implementations, the apparatus may include a second lenticular screen. The housing may support the second lenticular screen, the first lenticular screen may define a first side portion of the apparatus, the second lenticular screen may define a second side portion of the apparatus, and the first side portion and the second side portion may face in different directions.

In some such implementations, the second lenticular screen may have a plurality of second lenticules extending along corresponding second paths, each first path may be at a corresponding first angle relative to a first edge of the first lenticular screen, each second path may be at a corresponding second angle relative to a second edge of the second lenticular screen, the first edge of the first lenticular screen may be a closest edge of the first lenticular screen to the second edge of the second lenticular screen, and the first angle may be different from the second angle.

In some such implementations, the first angle may be an oblique angle and each second path may be perpendicular to the second edge.

In some alternative such implementations, the first angle may be an oblique angle and each second path may be parallel to the second edge.

In some implementations, the apparatus may further include a gaming machine cabinet, and the housing may be mounted to the gaming machine cabinet.

In some such implementations, the housing may extend along a side edge of the gaming machine cabinet.

In some alternative or additional such implementations, the housing may extend along a horizontal edge of the gaming machine cabinet.

In some further alternative or additional such implementations, the housing may extend along a curved edge or a curved surface of the gaming machine cabinet.

In some implementations, the apparatus may further include a controller configured to selectively control proper subsets of the light sources to switch each light source in each proper subset of the light sources between two or more states, each state differing from the other state or states in terms of one or both of color of light emitted by that light source and magnitude of light emitted by that light source.

In some such implementations, the controller may be, or may be in communication with, an electronic gaming machine controller.

These and other implementations are discussed below with respect to the drawings.

### BRIEF DESCRIPTION OF THE DRAWINGS

FIG. 1 is an exemplary diagram showing several EGMs networked with various gaming-related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIG. 4 depicts an example electronic gaming machine cabinet that houses a main display, a button deck, and two lighting modules.

FIG. 5 depicts the example electronic gaming machine cabinet of FIG. 4 but with the lighting modules removed.

FIG. 6 depicts the left lighting module of FIG. 4.

FIGS. 7 through 12 depict exploded views of the portion of the lighting module indicated in FIG. 6 for various implementations.

FIGS. 13 and 14 depict diagrams of different arrangements of second paths.

FIG. 15 depicts a front view of the lighting modules of FIGS. 7 through 12.

FIG. 16 depicts a side section view of the lighting module along the section line indicated in FIG. 15.

FIG. 17 depicts an isometric view of the lighting module of FIG. 15.

FIG. 18 depicts an isometric view of a section of a lighting module that features a first lenticular screen that is curved or arcuate in cross-section.

FIG. 19 depicts a side view of the lighting module of FIG. 18.

FIG. 20 depicts an exploded view of the lighting module of FIG. 18.

FIG. 21 depicts an isometric view of a section of a lighting module that features a first lenticular screen that is curved or arcuate in cross-section.

FIG. 22 depicts a side view of the lighting module of FIG. 21.

FIG. 23 depicts an exploded view of the lighting module of FIG. 21.

FIG. 24 depicts multiple views of a prototype lighting module with a single row of light sources contained within a housing.

FIG. 25 depicts the same lighting module as in FIG. 24 but with four different lenticular screen configurations.

FIG. 26 depicts the same lighting module as in FIG. 24, but from different viewing angles.

FIGS. 27 and 28 depict a prototype lighting module exhibiting different types of overlapping scale effects.

FIG. 29 depicts various states of operation for a lighting module demonstrating a movement effect in the lighting pattern.

FIG. 30 depicts potential locations on an electronic gaming machine cabinet where lighting modules such as those discussed herein may be used.

The Figures are provided for the purpose of providing examples and clarity regarding various aspects of this disclosure and are not intended to be limiting.

### DETAILED DESCRIPTION

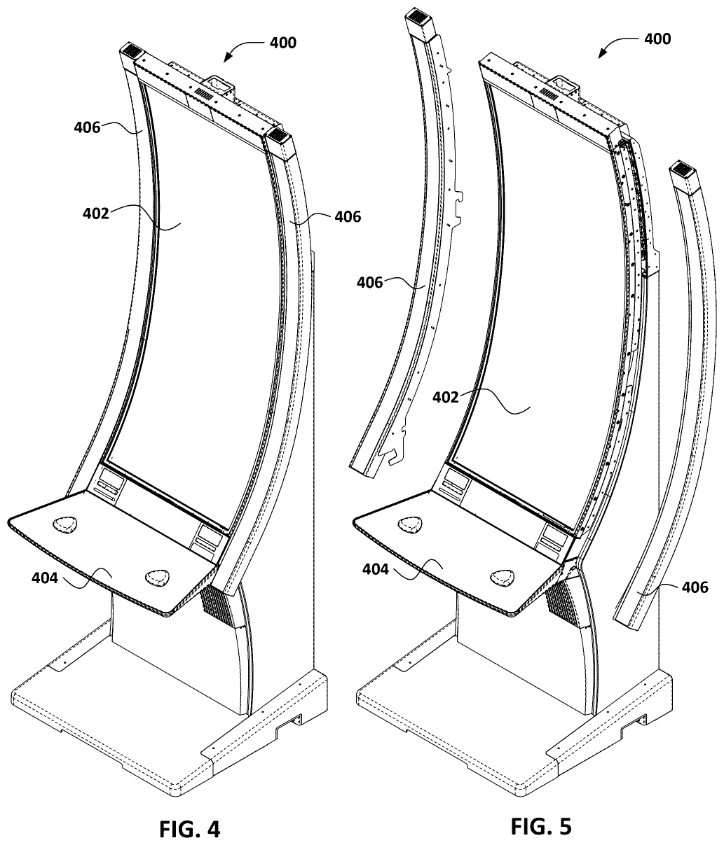

The following discussion provides overall context for electronic gaming machines, some of which may include lighting modules such as those discussed later herein with respect to FIG. 4 onwards.

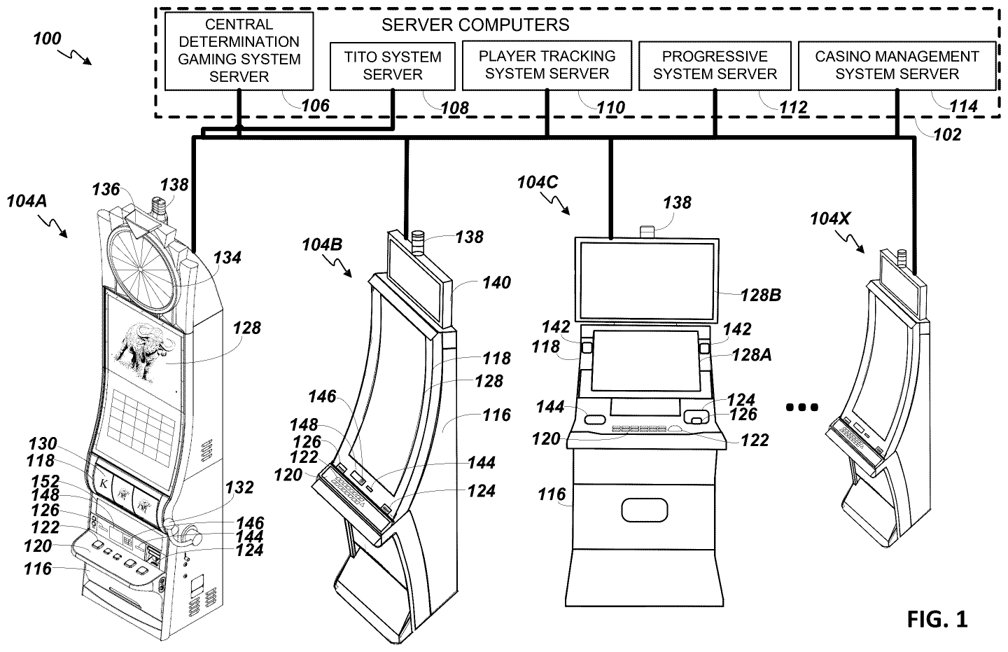

FIG. 1 illustrates several different models of EGMs which may be networked to various gaming-related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementations, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

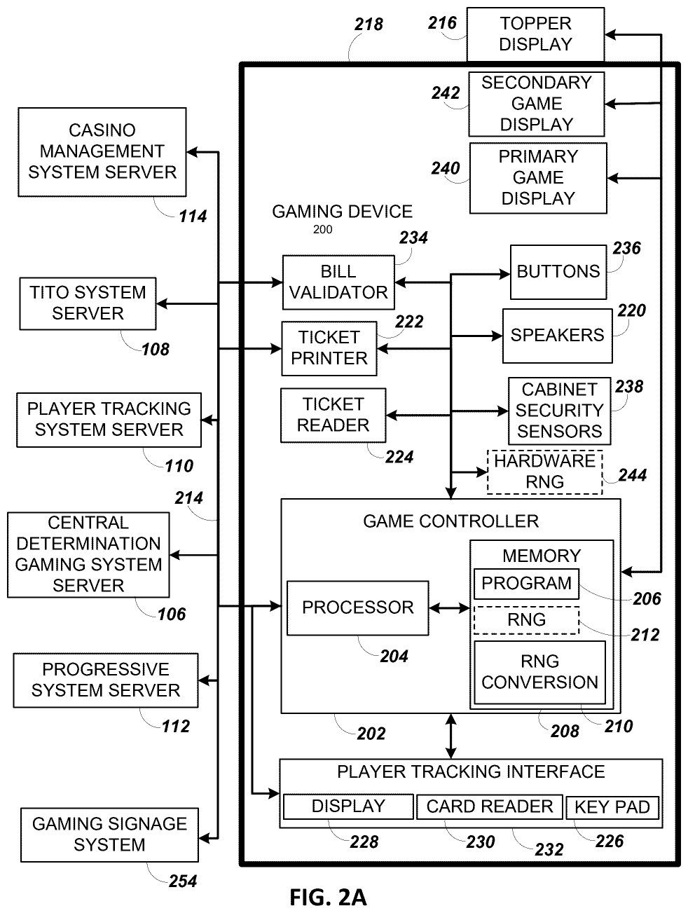

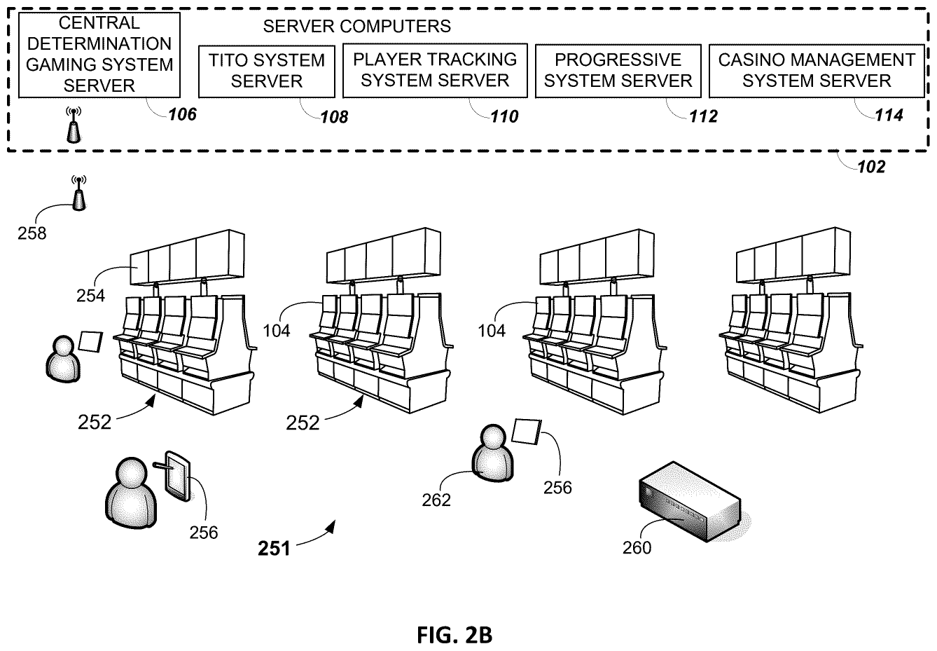

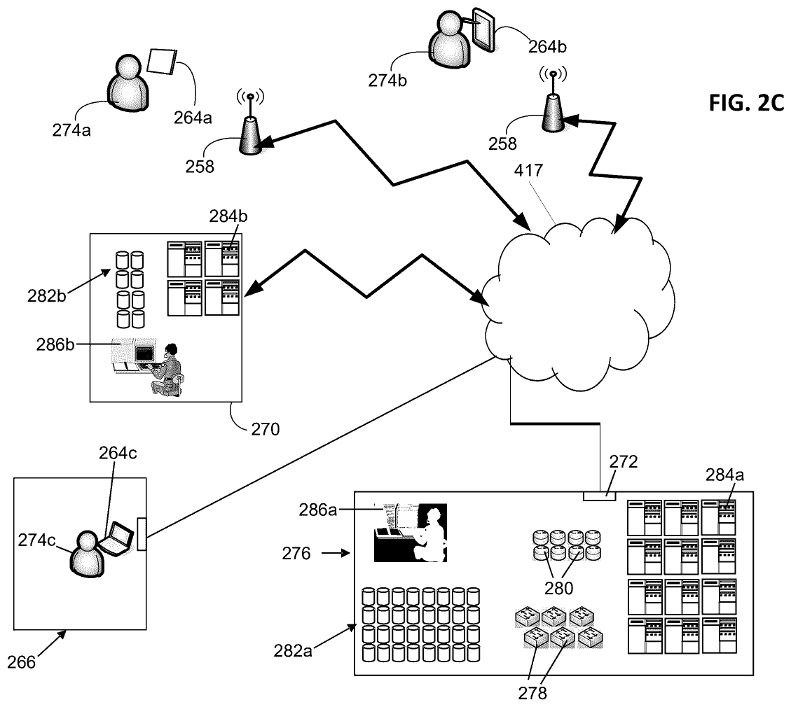

Many or all the above-described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play or any other information or media desired by the game designer or operator. In some implementations, example gaming device 104C may also include speakers 142 to output various audio such as game sound, background music, etc.

Many different types of games, including mechanical slot games, video slot games, video poker, video black jack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data.

Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness.

Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g., amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming.

For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 may, for example, be a remote gaming server (RGS) or similar system in some implementations. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 570a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

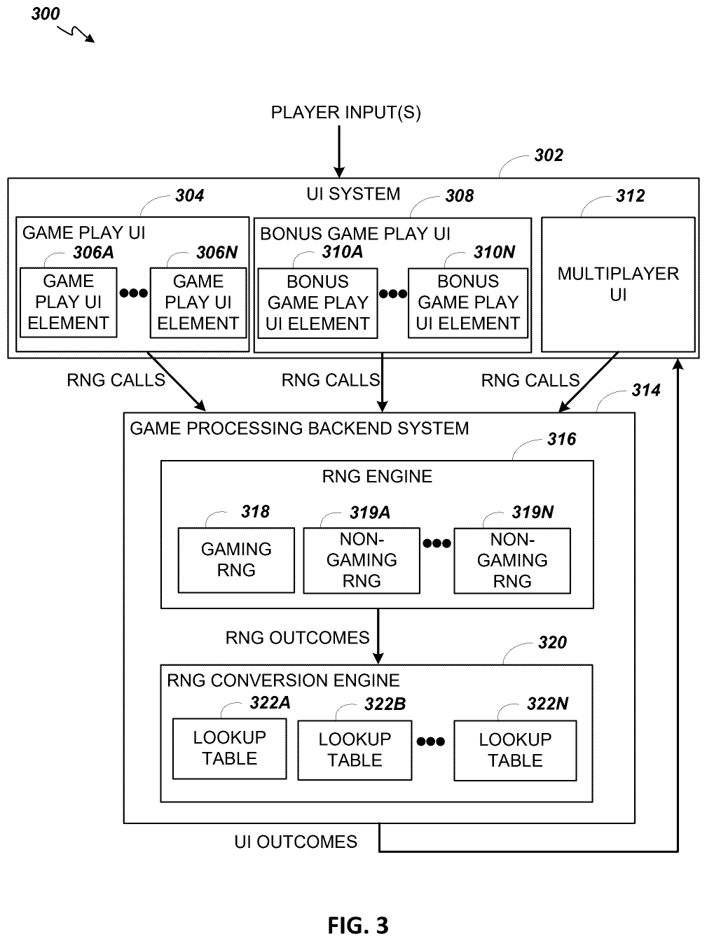

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

As discussed earlier, electronic gaming machines may incorporate a wide variety of audiovisual devices, e.g., speakers, displays, lighting devices, etc. As electronic gaming machines continue to grow in physical size and/or complexity, the number of such audiovisual devices, and their power needs, have tended to increase. It is not uncommon for modern electronic gaming machines to draw 500 or 600 watts (or more) during operation. Taking into account that a given casino may operate hundreds or thousands of electronic gaming machines on a continuous basis, the amount of electrical power that such a casino may need to pay for in order to keep the electronic gaming machines ready for play may cost hundreds of thousands of dollars per year.

Disclosed herein are lighting modules that may be used in electronic gaming machines in order to present lighting effects in a more energy-efficient manner. The lighting modules may incorporate a plurality of light sources, e.g., light-emitting diodes (LEDs), a housing, and a lenticular screen. The housing may support the light sources and the lenticular screen in a spaced-apart manner such that there is an air gap between the light sources and the lenticular screen. By doing so, the light from the light sources has a chance to spread outward in a relatively omnidirectional manner before striking the lenticular screen. Once the light reaches the lenticular screen, the lenticules of the lenticular screen act to redirect the light into a more focused form. As a result, to an outside viewer, the light emitted by such modules may appear to have various complex geometric shapes that may pique a viewer's interest. For example, the light may appear to be emitted along an oblong or elongate strip that may, depending on the orientation of the lenticules in the lenticular screen relative to the viewer, be oriented at various angles. In some instances, the light may appear to be emitted along an arcuate path. Such implementations may give the appearance of there being a larger number of light sources than are actually present, thereby providing visual effects that are associated with systems that have a higher power consumption (by virtue of having more light sources) but doing so with a lower number of light sources. This has the effect of allowing for more complex illumination effects to be provided while reducing power consumption as compared with alternative devices that might be used to provide similar effects.

FIG. 4 depicts an example electronic gaming machine cabinet 400 that houses a main display 402, a button deck 404, and two lighting modules 406. The lighting modules 406, which are shown in FIG. 5 removed from the gaming machine cabinet 400, may, as in this example, each take the shape of a concave elongate curved strip that matches the concave curvature of the main display 402. However, in other implementations, the lighting modules 406 may take other forms, such as convex elongate strips, flat elongate strips, or a mixture of such profiles. The lighting modules 406 may also have shapes that are not necessarily elongate, e.g., circular, square, etc.

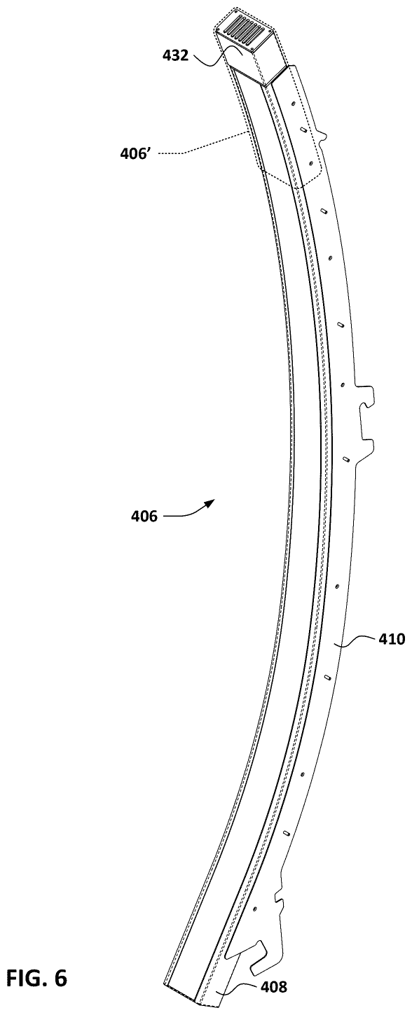

FIG. 6 depicts the left lighting module 406 in isolation. The lighting module 406 has a bracket 410 on the right side that may be used to attach the lighting module 406 to the electronic gaming machine cabinet 400, although other types of connection may be used as well, e.g., mounting features that are integrated into the lighting module 406 housing 408. The lighting module 406 may include, as in this example, an integrated controller 432, which may include, for example, control circuitry and power management circuitry for controlling the light sources within the lighting module 406. In this example, the controller 432 is mounted to the housing 408 such that the lighting module 406 and controller 432 form a complete subassembly. In other implementations, the controller 432 (or components that provide similar functionality) may be located elsewhere (e.g., within the electronic gaming machine cabinet 400), and connected with the light sources within the housing 408 via one or more cables.

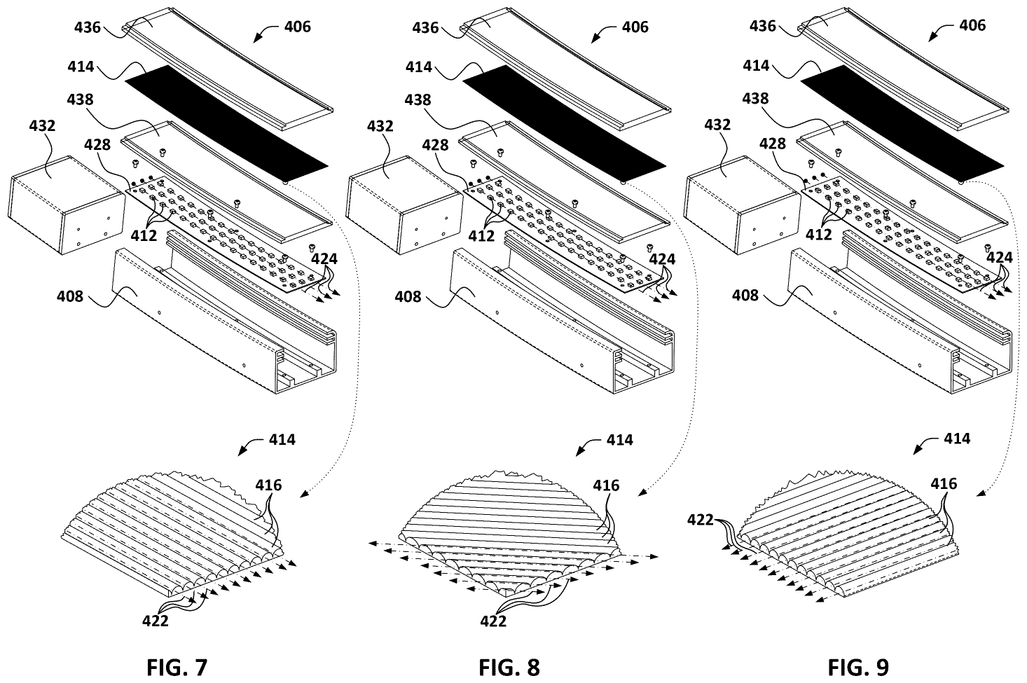

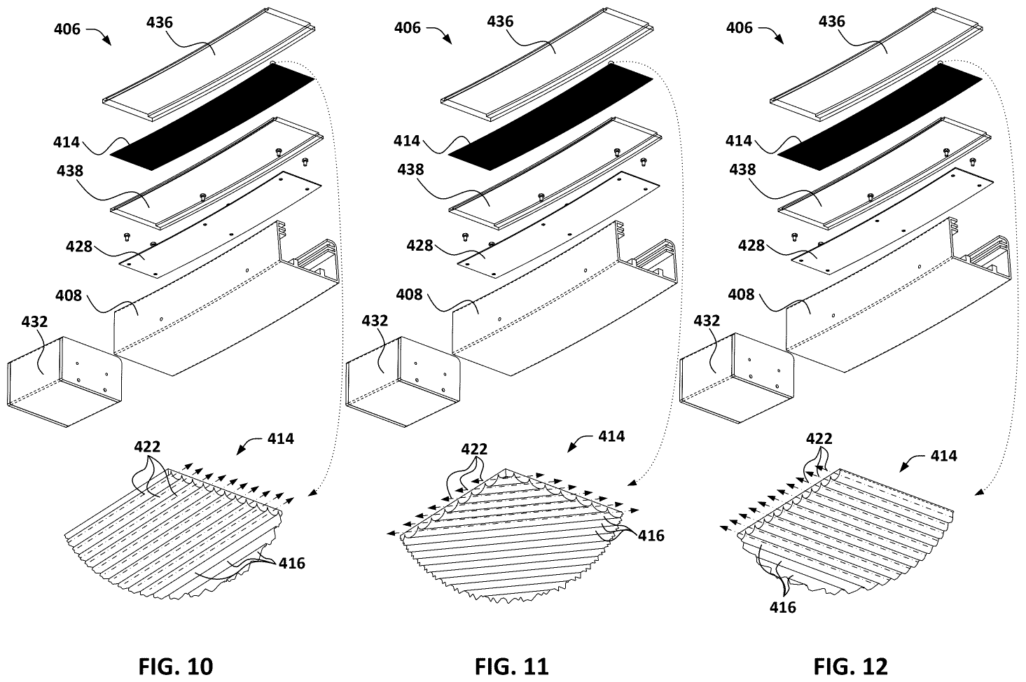

The portion of the lighting module 406 enclosed within the dotted boundary 406′ is shown in more detail in FIGS. 7 through 12 for various implementations. FIGS. 7 through 12 depict the portion 406′ of the lighting module 406 for various implementations of the lighting module 406 in an exploded view. Each of FIGS. 7 through 12 also includes a partial detail view of a portion of the lenticular screen used in each implementation. It will be understood that FIGS. 7 through 9 depict the portion 406′ of the lighting module 406 from a viewpoint in which the “front” surface of the lighting module 406 is visible (the “front” surface of the lighting module 406, in this example, is the light-emitting side or surface of the lighting module 406), while FIGS. 10 through 12 depict the portion 406′ of the lighting module 406 from a viewpoint in which the “rear” surface of the lighting module 406 is visible (opposite the “front” surface).

In FIG. 7, it can be seen that the lighting module 406 may include a substrate 428 that has a plurality of light sources 412 mounted thereto. The lighting module 406 may also include a first lenticular screen 414 that has a plurality of first lenticules 416 that extend along first paths 422. The light sources 412 may, for example, be LEDs and may be either single-color, e.g., red, green, blue, yellow, etc., or may be multi-spectrum or multi-color LEDs that may be controlled to emit light of multiple different spectral profiles at different times such that the wavelength of light that is emitted by such light sources may be adjusted in real-time in order to produce various effects, e.g., giving the appearance that the light emitted by the light sources is moving, or that the color of the light emitted by the light sources is changing color progressively along the length of the substrate 428.

It will be understood that the substrate 428 may be continuous or may be provided as multiple discrete pieces that may be connected together electrically via butt connectors or flexible cables that may connect two substrates 428 together. For example, in the depicted lighting module 406, the substrate 428 is composed of multiple shorter strips of substrate 428 that are connected together electrically. This facilitates manufacture since the extremely large length-to-width aspect ratio of the substrate 428 may make it difficult to handle the substrate 428 as a single, long piece using commonly available surface-mount printed circuit board fabrication and component mounting systems. The substrate 428 may, in some instances, be a flexible substrate, such as a flexible printed circuit board but may, in other instances, be a rigid printed circuit board (which may still have some amount of flexibility)—in the example lighting module 406, the substrate 428 may be either a flexible printed circuit board or a rigid printed circuit board (which may, due to the shallow curvature of the housing 408, be forced into a “flexed” or curved configuration by the housing 408 when mounted to the housing 408).

The light sources 412 mounted to the substrate 428 may be surface-mount LEDs or other lighting devices and may be arranged along one or more second paths 424. In the example lighting module 406, the light sources 412 are evenly distributed along three separate second paths 424, e.g., positioned along each second path 424 in an evenly spaced manner, but it will be understood that the light sources 412 for a lighting module 406 may be arranged along a single second path 424, two second paths 424, four second paths 424, five second paths 424, etc.

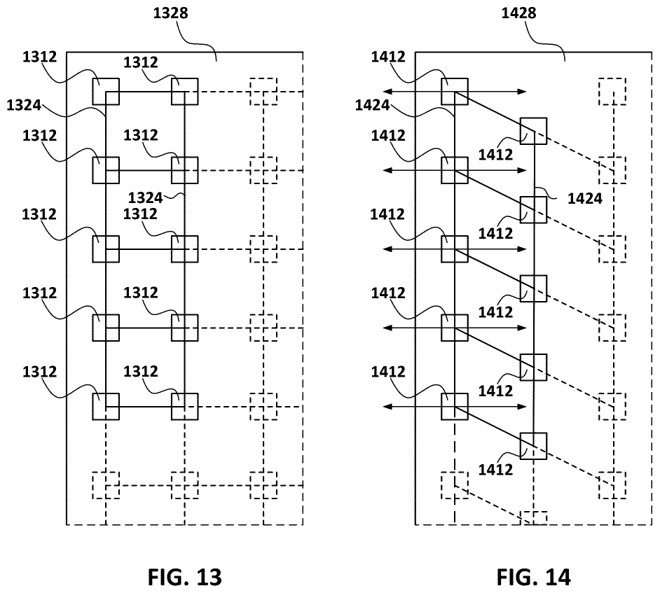

The second paths 424 may, for example, be identically shaped and oriented in some implementations. For example, in the depicted lighting module, the three second paths 424 are identical to one another except that they are spaced apart from one another along an axis, e.g., along an axis transverse to the long axis of the substrate 428, generating, in effect, a rectangular array of light sources 412 along the curved surface of the substrate 428. In the depicted example, each second path 424 defines a plane (since each second path 424 is, in this example, arcuate, each second path 424 would necessarily define a plane), and the axis along which the second paths 424 are arranged may be perpendicular to those planes. Other configurations of second paths may be used as well—this is but one example arrangement and is not limiting. FIG. 13 depicts a diagram of such an arrangement of second paths. As can be seen in FIG. 13, a substrate 1328 has a plurality of second paths 1324 that are identical and offset from one another along a direction perpendicular to the second paths 1324 (ten light sources 1312 are arranged along the two second paths 1324 that are visible, but the number of light sources 1312—and second paths 424—may be expanded beyond the number shown, as indicated by the broken line representations of additional light sources 1312 and second paths 1324.

In some implementations, the positioning of the light sources 412 along adjacent or adjoining second paths 424 may be staggered such that the resulting array of light sources 412 is a staggered or parallelogram array. Put another way, the light sources 412 along one second path (“A”) may be positioned along that second path 424 “A” such that axes that are transverse to both the second path “A” and an adjacent second path 424 “B” and that pass through the centers of the light sources 412 along the second path 424 “A” are offset in directions perpendicular to those axes from the centers of the light sources 412 along the second path 424 “B.” FIG. 14 depicts a diagram of such an arrangement of second paths. In FIG. 14, a substrate 1428 is shown that has a plurality of light sources 1412 arranged along second paths 1424. As can be seen, the light sources 1412 that lie along the left-most second path 1424 have centers that lie along axes (represented by double-ended arrows) that are transverse to the second paths 1424, and the light sources 1412 that lie along the adjacent second path 1424 have centers that are offset from, and in a direction perpendicular to, those axes.

The housing 408 may, for example, be made of plastic, metal, or other suitable material, and may have features that allow the housing 408 to support the first lenticular screen 414, either directly or indirectly, relative to the light sources 412. In the depicted example, the housing 408 is in the form of an extrusion, e.g., an aluminum or plastic extrusion, that has a generally C-shaped cross-section having two opposing side walls linked together by a base wall. The base wall, for example, may have one or more raised regions that may act as supports for the substrate 428 and that may, for example, have threaded holes or other features that may be engaged with fasteners that may secure the substrate 428 to the housing 408. The side walls, in this example, each have a set of flanges or fingers at the ends of the side walls opposite the base wall that extend from each side wall towards the opposing side wall. The flanges or fingers of each side wall may be spaced apart from one another to define channels or grooves that may be used to receive the first lenticular screen 414, for example, or to receive another component or components that may be used to support and/or protect the first lenticular screen 414. For example, in the lighting modules 406, each lighting module 406 includes a first transparent layer 436 and a second transparent layer 438. The first transparent layer 436 may be positioned adjacent the first lenticular screen 414 such that the first lenticular screen 414 is positioned between the first transparent layer 436 and the substrate 428/light sources 412 and may act as a transparent, protective shield that may protect the first lenticular screen 414 from potential damage, e.g., from a bystander that might accidentally strike the lighting module 406 with a hard object and possibly scratch the first lenticular screen 414 or push against the first lenticular screen 414—since the first lenticular screen 414 may be quite thin, e.g., on the order of tenths of a millimeter thick, such interactions may cause the first lenticular screen 414 to deform and become unseated from the housing 408. The first transparent layer 436 may prevent such potential damage and may also, in some instances, act to help support the first lenticular screen 414. The second transparent layer 438, if used, may primarily serve to provide support to the first lenticular screen 414 and may, if present, be positioned adjacent to the first lenticular screen 414 such that the first lenticular screen 414 is between the first transparent layer 436 and the second transparent layer 438. While the second transparent layer 438 would, if present, also protect the first lenticular screen 414 from damage originating from within the housing 408, it is unlikely that the interior of the housing 408 would present a risk of damage to the first lenticular screen 414. As noted above, the first transparent layer 436 and the second transparent layer 438 (if present) may provide support for the first lenticular screen 414. In some such implementations, the first lenticular screen 414 may be entirely supported by the first transparent layer 436 and the second transparent layer 438, which may, in turn, be supported by the housing 408, thereby allowing the housing to indirectly support the first lenticular screen 414.

The first transparent layer 436 and the second transparent layer 438, in this example, are made of an optically transparent material, such as acrylic, polycarbonate, glass, or other suitable substance. The first transparent layer 436 and the second transparent layer 438 also, in this example, have “T” shaped cross-sections, featuring a thicker middle portion with thinner flanges or wings protruding from opposing long edges. The thinner flanges or wings are sized to slide into the channels or grooves defined by the flanges or fingers extending from the side walls of the housing 408, thereby securing the first transparent layer 436 and the second transparent layer 438 in place relative to the housing 408 (in directions normal and transverse to the substrate 428; the controller 432 and an endcap (not shown) for the housing 408 may be used to provide securement of the first transparent layer 436 and the second transparent layer 438 in directions parallel to the path defining the long axis of the housing 408), the substrate 428, and the light sources 412.

FIGS. 8 through 12 depict the same components as discussed above, positioned and used in the same manner as described above relative to FIG. 7. Where the implementations of FIGS. 7 through 12 differ is in the configuration of the first lenticular screen 414. A “lenticular screen,” as the term is used herein, refers to a rigid or flexible layer made of an optically transparent material. This layer may generally have a first major side and a second major side opposite the first major side (such layers may often be in the form of a sheet or other thin material, and the first and second major sides of such layers may generally correspond to the front and back (or vice-versa) of such a sheet of material). In a lenticular screen, one or the other of the first side may have a series of lenticules that each extend along a corresponding first path. The lenticules are generally arranged in a linear array, each positioned adjacent to a neighboring lenticule or neighboring lenticules, although in some lenticular screens, there may be small gaps between lenticules, e.g., smaller than the transverse width of the lenticules. Each lenticule may generally have the form of a prismatic lens, e.g., having a generally constant cross-section in planes perpendicular to, and located along, the first path. The lenticules may be connected to one another, e.g., directly to one another along their long edges and/or by way of protruding from a common layer or sheet of material. For example, a lenticular screen may include a sheet of material that is smooth on one side and have a plurality of lenticules protruding from the other side of the material, like a series of parallel ridges. The cross-sections for the lenticules in planes perpendicular to their respective first paths may be semi-circular or arcuate in shape.

The implementations of the lighting module 406 in FIGS. 7 through 12 feature first lenticular screens 414 that are arranged in different orientations. In the implementations of FIGS. 7 through 8, the first lenticules 416 of the first lenticular screen 414 are located on the side of the first lenticular screen 414 that faces away from the light sources 412, whereas in the implementations of FIGS. 10 through 12, the first lenticules 416 of the first lenticular screen 414 are located on the side of the first lenticular screen 414 that faces towards the light sources 412. The lighting module 406 may produce similar visual effects regardless of the facing orientation of the first lenticular screen 414.

However, the orientation of the first lenticules 416, i.e., the orientation of the first paths 422, of the first lenticular screen 414 relative to an edge, e.g., a first edge 426, of the first lenticular screen 414 may produce different visual effects in the lighting module 406 depending on the orientation. The detail views in FIGS. 7 through 12 show different potential orientations of the first paths 422 in each first lenticular screen 414. For example, in FIGS. 7 and 10, the first paths 422 followed by the first lenticules 416 extend along directions generally parallel to the first edge 426 (the first edge 426, in these examples, is the long edge of the first lenticular screen 414). Thus, each first lenticule 416 is generally as long as the length of the first lenticular screen 414 along its long axis. In FIGS. 9 and 12, however, the first paths 422 followed by the first lenticules 416 extend along directions generally perpendicular to the first edge 426, and are each generally as long as the width of the first lenticular screen 414 along its transverse axis.

Finally, in FIGS. 8 and 11, the first paths 422 followed by the first lenticules 416 extend along directions that are oblique to where each first path 422 passes across the first edge 426, e.g., at first oblique angles relative to the first edge 426 (for clarity, the first oblique angles are understood to be the acute oblique angles defined by the first paths 422 and the first edge 426—each first path 422 would also define an obtuse oblique angle relative to the first edge 426). In some instances, the first oblique angles defined by the first edge 426 and the first paths 422 may be angles between 30° and 60°, between 40° and 60°, or approximately 45°, e.g., 45°±2°. The various effects achieved by such orientations are discussed later in this paper.

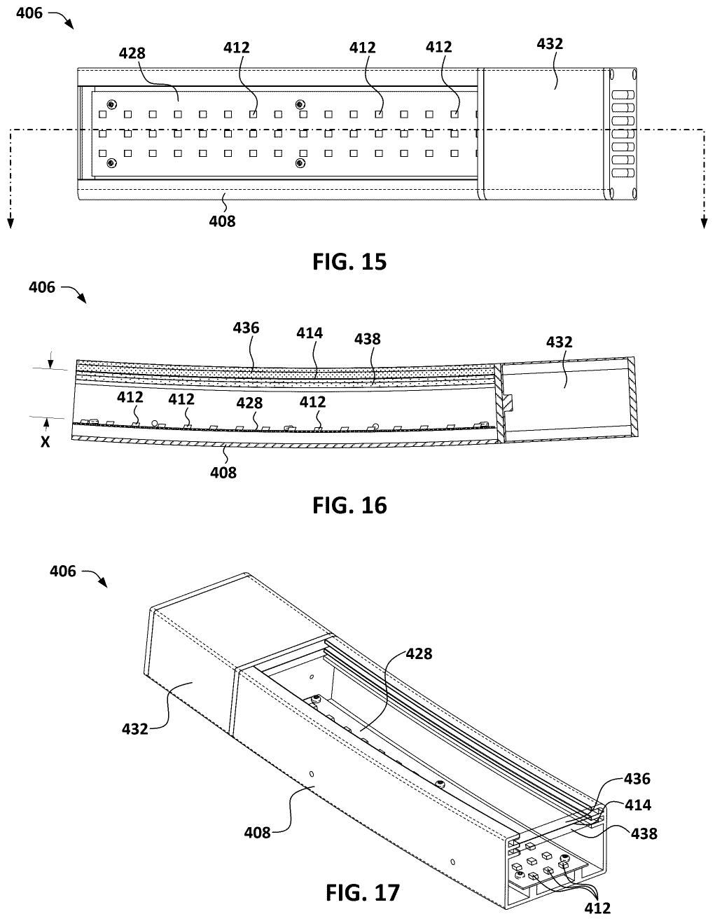

FIGS. 15 through 17 depict the lighting modules 406 of FIGS. 7 through 12 in an assembled state, with FIG. 15 depicting a front view of the lighting module 406, FIG. 16 depicting a side section view of the lighting module 406 along the section line indicated in FIG. 15, and FIG. 17 depicting an isometric view of the lighting module 406. The first lenticular screen 414 is shown as completely transparent in these Figures, but would, in actual practice, appear only somewhat translucent to an observer, thereby masking the light sources 412, the substrate 428, and the interior surfaces of the housing 408 from view. As can be seen in FIG. 16, the housing 408 may support the first lenticular screen 414 a distance X from the light sources 412. In some implementations, the distance X may be at least 0.25 inches. Having the distance X be 0.25 inches or greater may help ensure that the light from the light sources 412 has sufficient opportunity to spread before passing through the first lenticular screen 414 such that the visual effect produced when such light passes out of the other side for the first lenticular screen 414 has the appearance of a noticeably elongated illumination zone. If the distance X is less than 0.25 inches, the first lenticular screen 414 may have little effect on the spread of the light from the light sources 412, e.g., making the light appear to come from a point light source as opposed to from an elongate light source.

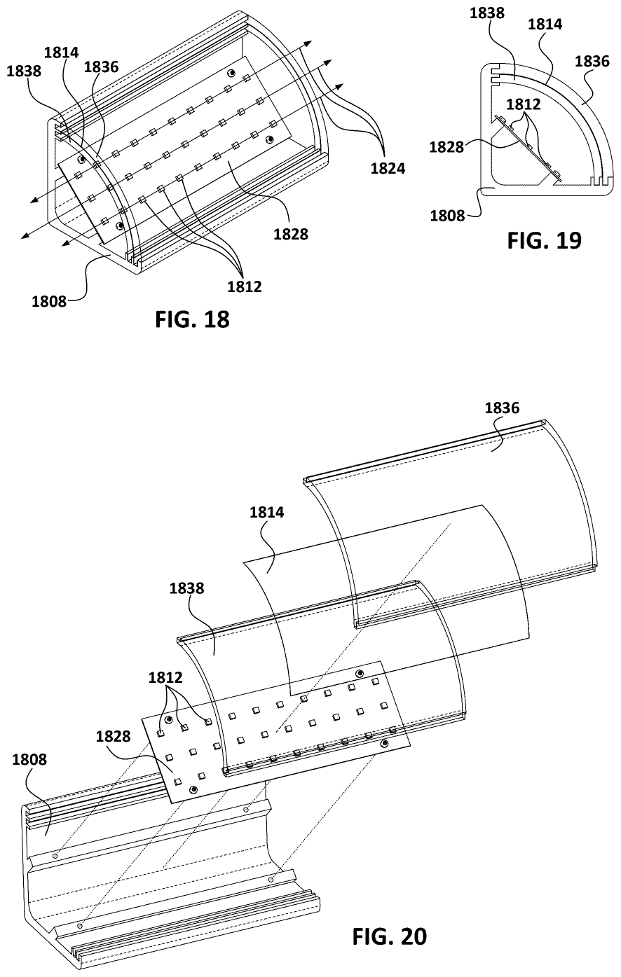

FIGS. 18 through 23 depict two further implementations of lighting modules that may be used to implement the concepts discussed herein; these are presented as additional examples and are non-limiting. Other implementations of lighting modules implementing the concepts discussed herein are also understood to be within the scope of this disclosure.

FIG. 18 depicts an isometric view of a section of a lighting module 1806 that features a first lenticular screen 1814 that is curved or arcuate in cross-section, e.g., forming an arcuate profile about an axis that is parallel to the second axes 1824; the arcuate profile is visible in FIG. 19. FIG. 20 depicts an exploded view of the lighting module 1806. The first lenticular screen 1814 is sandwiched between a first transparent layer 1836 and a second transparent layer 1838 that are slid into channels on a housing 1808. The first transparent layer 1836 and the second transparent layer 1838 have cross-sectional profiles that are similar in shape to the profile of the first lenticular screen 1814. A substrate 1828 is mounted to the housing 1808 and may be oriented to face towards a centerline of the first lenticular screen 1814 such that light sources 1812 direct light towards the first lenticular screen 1814. The first lenticular screen 1814 may have lenticules (not shown) that are oriented relative to one of the edges of the first lenticular screen #Oo14 in any of the manners discussed above with respect to the lighting module 406. The lighting module 1806 may, for example, be used to illuminate a corner or edge of a larger device, such as an electronic gaming machine cabinet.

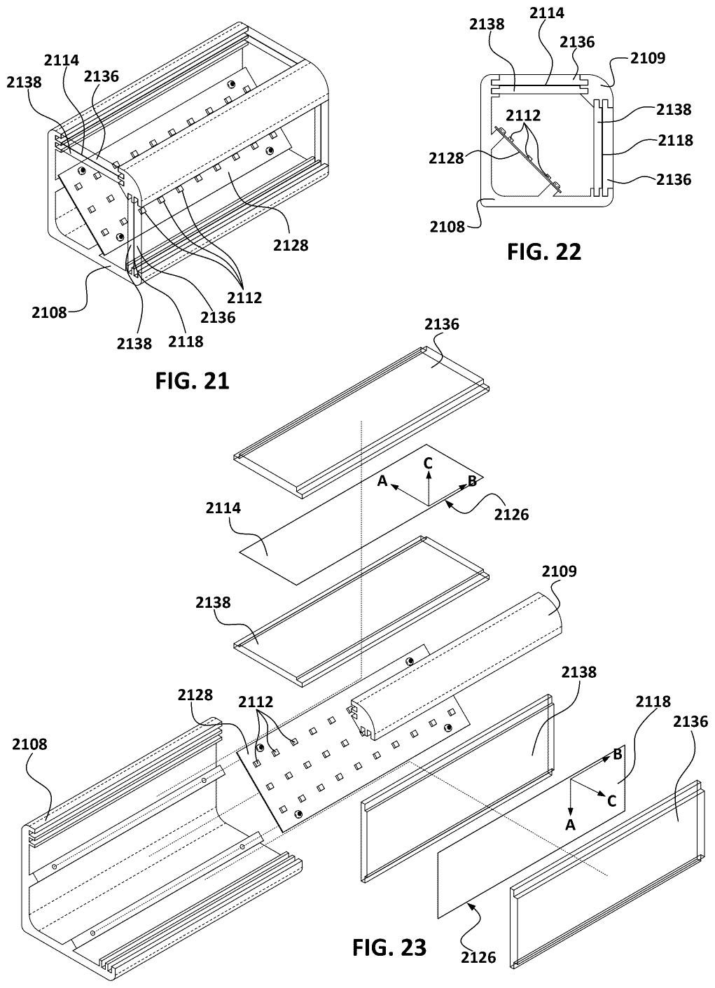

FIG. 21 depicts an isometric view of a section of a lighting module 2106 that features two lenticular screens—a first lenticular screen 2114 and a second lenticular screen 2118. The first lenticular screen 2114 and the second lenticular screen 2118 may each be sandwiched between a corresponding first transparent layer 2136 and a corresponding second transparent layer 2138. The lighting module 2106 features a housing 2108 that is similar to the housing 1808 but includes a second portion in the form of corner piece 2109, forming a rectangular or square cross-section as shown in FIG. 22. Each of the first transparent layers 2136 and the second transparent layers 2138 may, for example, span between the housing 2108 and the corner piece 2109. In some implementations, the corner piece 2109 may be joined to, e.g., via adhesives, the first transparent layers 2136 and/or the second transparent layers 2138 for increased structural stability. A substrate 2128 supporting light sources 2112 may be provided within the housing 2108 such that light emitted by the light sources 2112 may be directed out of one or both of the first lenticular screen 2114 and the second lenticular screen 2118. In some implementations, the first lenticular screen 2114 and the second lenticular screen 2118 may each be provided light from a separate set of light sources 2112 and an opaque wall may be interposed within the housing 2108 so as to prevent light from one set of light sources from reaching the lenticular screen associated with the other set of light sources. For example, the portion of the corner piece 2109 (which may be opaque as well) facing towards the substrate 2128 may be extended until it reaches the substrate 2128 (and the light sources 2112 in the middle row of light sources 2112 may be omitted), thereby walling off the two remaining rows of light sources from one another, and allowing the illumination effects provided via both lenticular screens to be independently controlled.

In such an arrangement, the first lenticular screen 2114 may define a first side portion of the lighting module 2106 while the second lenticular screen 2118 may define a second side portion of the lighting module 2106 that faces in a different direction from the first side portion. This allows for the lighting effects provided by the lighting module 2106 to be visible from different sides of the lighting module and potentially allows the lighting effects that are visible on each side to be different.

For example, the use of multiple lenticular screens in the lighting module 2106 allows, if desired, the lenticules for each lenticular screen to be oriented differently relative to the edges 2126 of the lenticular screens that are closest to one another. For example, in FIG. 23, which is an exploded view of the lighting module 2106, directional rosettes marking directions parallel (A) to the edges 2126 of the lenticular screens, perpendicular (B) to the edges 2126, and at oblique angles (C) to the edges 2126 are shown. The first lenticular screen 2114 may, for example, have first paths followed by its respective lenticules that are at a first angle relative to the edge 2126 of the first lenticular screen 2114, e.g., that extend along one of the directions A, B, or C, while the second lenticular screen 2118 may have corresponding second paths followed by its respective lenticules that extend along either the same direction A, B, or C relative to the edge 2126 of the second lenticular screen 2118 or, in some implementations, along another of the relative directions A, B, or C for that lenticular screen. It will be understood that directions C may be at any oblique angle relative to the edges 2126 (and may be different for both lenticular screens).

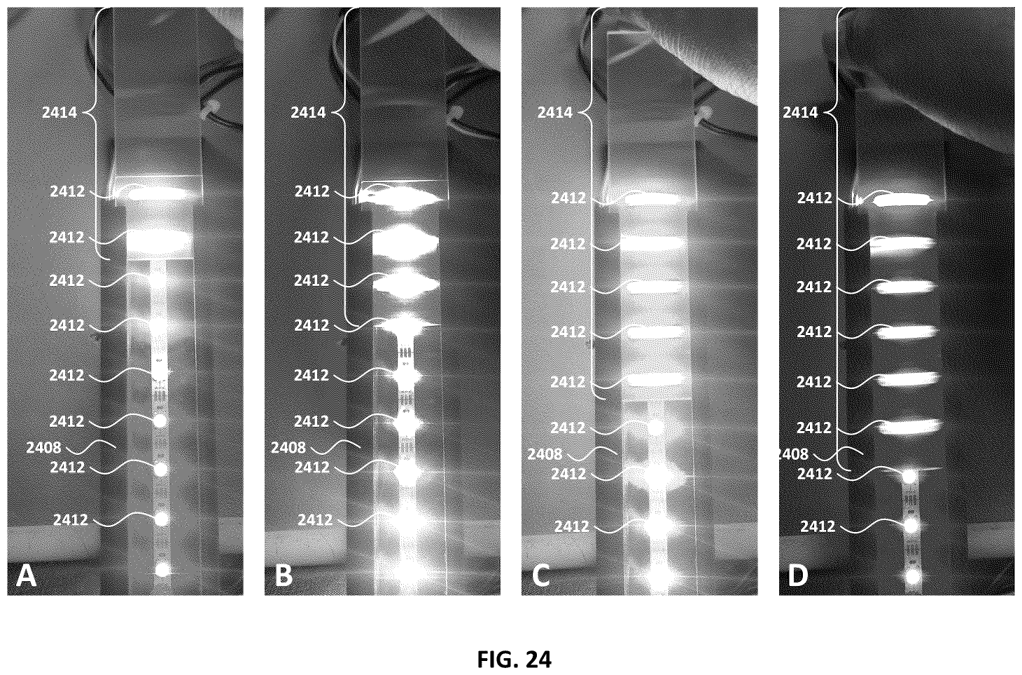

Some of the lighting effects that may be produced by lighting modules such as those discussed above are discussed below with respect to FIGS. 24 through 28. FIG. 24 depicts multiple views of a prototype lighting module with a single row of light sources 2412 contained within a housing 2408 (which is similar to the housing 408). In view A, a first lenticular screen 2414 has been partially slid into the housing 2408 such that the first lenticular screen 2414 covers the uppermost two light sources 2412. The first lenticular screen 2414, in this example, has first lenticules that extend along first paths that are, relative to the orientation of FIG. 24, vertical. As can be seen, the light passing through the first lenticular screen 2414 from the uppermost two light sources appears to be from an oblong light source that extends from one side of the first lenticular screen 2414 to the other. In contrast, the remaining light sources 2412 are clearly recognizable as round LEDs (the third and fourth light sources 2412 from the top exhibit some blooming/reflection, but this is a photographic artifact caused by the fact that these light sources 2412 were illuminated with a different wavelength of light than the ones below them when the photo for view A was taken).

In views B through D, the first lenticular screen 2414 is slid further and further into the housing 2408, and it can be seen how the light sources 2412 that are behind the first lenticular screen 2414 have very uniformly defined, oblong or elongate illumination patterns, while the light sources 2412 that are not covered by the first lenticular screen 2414 have round or point-shaped appearances (again, the four lower light sources in view C are emitting light of a wavelength that causes some optical blooming effect in the camera, but are generally still recognizable as LED light sources.

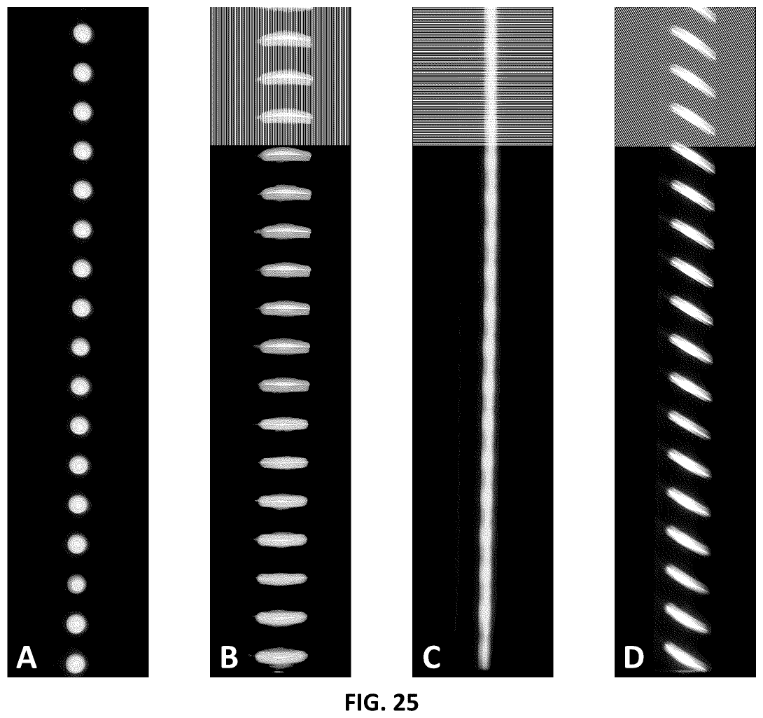

FIG. 25 depicts the same lighting module, but in four different configurations. In view A, the lighting module is shown with no lenticular screen installed, and the strip of light sources that are housed within the lighting module are visible as a linear series of round light sources (LEDs). In view B, a lenticular screen has been installed in the lighting module. The lenticules of the lenticular screen in view B extend along first paths that are parallel to the long edge of the lighting module. To aid in envisioning this, an array of parallel white lines that are parallel to the long edge of the lighting module is shown overlaid near the top edge of view B. As can be seen, the light from the light sources spreads out along axes that are generally transverse to the first paths followed by the lenticules of the lenticular screen, resulting in elongate lighting patterns that extend along directions perpendicular to the first paths. In view C, the lenticules of the lenticular screen extend along first paths that are perpendicular to the long axis of the lighting module, thereby causing the light from the light sources to fan out along a common axis and giving the appearance of a continuous line of illumination. In view D, the lenticules of the lenticular screen extend along first paths that are at an oblique angle, e.g., 30°, to the long edge or axis of the lighting module/lenticular screen. This causes the elongate lighting patterns produced by the light sources to be angled at oblique angles relative to the edges of the lenticular screen.

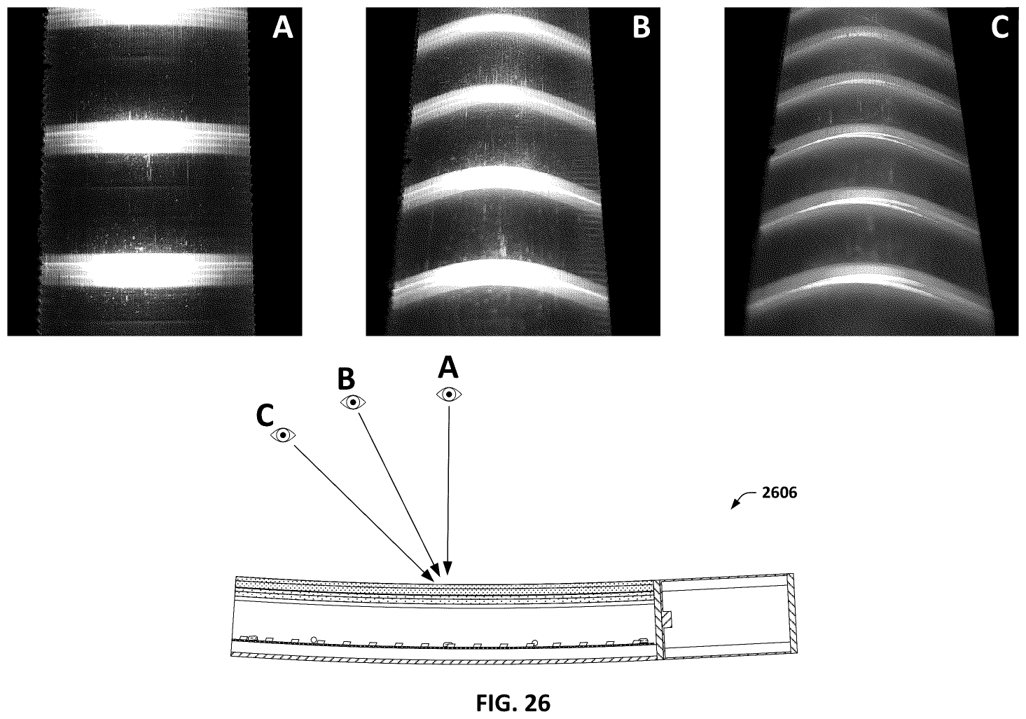

While it may appear that the lighting patterns produced by the light source light passing through the lenticular screen have a two-dimensional character (e.g., generally being elongate in a plane), the lighting patterns produced by the light source light passing through the lenticular screen also have a depth component that is not readily evident from the previous Figures. FIG. 26 is provided to demonstrate the depth effect. In FIG. 26, three photographs are shown of a portion of a lighting module 2606 with a lenticular screen having lenticules extending along first paths that are, relative to the figure orientation, vertical. The lighting module, shown in cross-section at the bottom of FIG. 26, has a single row of light sources within the housing thereof. When one looks at the lighting module along a direction that is perpendicular to the lenticular screen, e.g., along sight line “A,” the illumination patterns that are visible generally appear two-dimensional, e.g., elongate in a direction transverse to the first paths. However, if one looks at the lighting module along sight lines that are at oblique angles to the lenticular screen, e.g., along sight lines B or C (see views B and C), then the illumination patterns that are produced by each light source and the lenticular screen appear to be arced or curved—looking almost like bridges made of light.

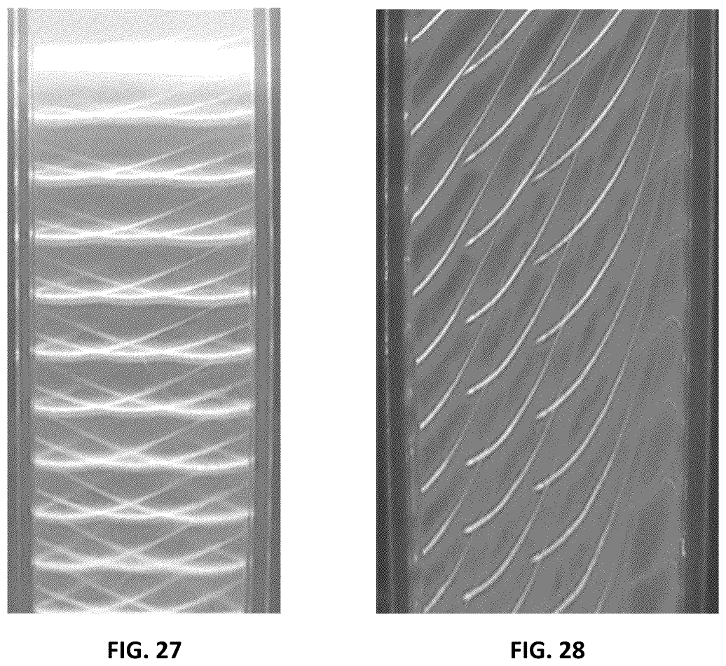

This arcing or curving effect can produce complex patterns that are visually intriguing. FIGS. 27 and 28 provide two examples of such effects. FIG. 27, for example, depicts a view of a lighting module like that of FIG. 26, but with three rows of light sources arranged side-by-side within the lighting module. The photo of FIG. 27 is taken along a sight line that is at an oblique angle to the lenticular screen used in the lighting module and in a plane that is parallel to the long edge of, and perpendicular to, the lenticular screen. As can be seen, the illumination patterns from each row of three light sources give the appearance of multiple, overlapping arcs—looking almost like fish or reptile scales. If the light sources were to be staggered, e.g., as discussed above with respect to FIG. 14, then the “scales” would similarly be staggered and would look even more like fish scales (which tend to overlap like shingles).

FIG. 28 depicts a similar lighting module, but one in which the lenticules of the lenticular screen are at oblique angles to the long edge of the lenticular screen; as can be seen, this also generates a “scale” effect, although one in which the arcs appear to overlap less and look more like overlapping scales (where each scale obscures the scale below it).

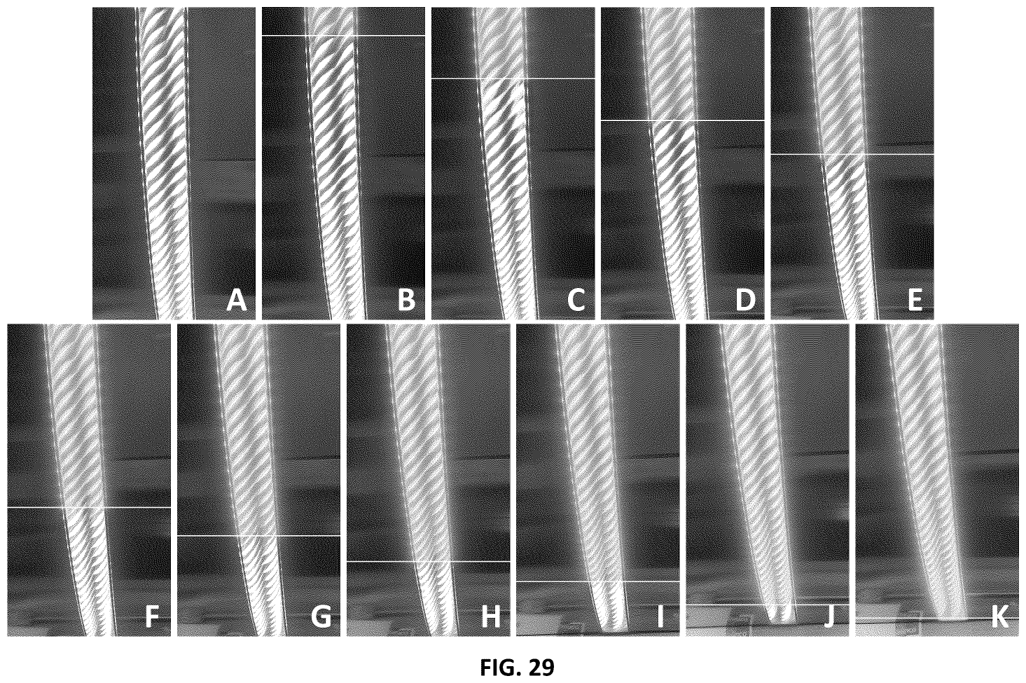

The use of lenticular screens in lighting modules such as are discussed herein allows for a relatively small number of energy efficient light sources, e.g., LEDs, to be used to generate large-area lighting patterns with intriguing geometries that may be particularly engaging to passers-by. It will be appreciated that the light sources in such lighting modules may be controlled to give the illumination patterns that are generated a “motive” appearance, e.g., by selectively causing various subsets of the light sources to undergo changes in brightness (magnitude of light emitted), color (wavelength or color of light emitted), or illumination state (e.g., on/off). FIG. 29 depicts a lighting module equipped with a lenticular screen having lenticules extending along first paths that are at an oblique angle to the long edge of the lenticular screen as the light sources within the lighting module are controlled to cause them to sequentially change color from top to bottom, e.g., along the second paths along which the light sources are arranged. The white line that is visible in views B through K indicates where the change in color occurs in each image. Such illumination control may be used to convey the appearance of movement of the illumination patterns, giving the lighting module a more dynamic appearance.

Another effect that may be obtained in such lighting modules, such as those of FIGS. 27 and 28, is to have the light sources that produce overlapping illumination patterns illuminate with different colors—this will cause the illumination patterns that arise to have correspondingly different colors, resulting in different colors of “scales” overlapping one another. Such colors may, for example, be starkly different (e.g., red v. green) or may be selected to be more subtle, e.g., using multiple shades of the same nominal color in order to convey a “fading” illusion indicative, for example, of depth or of something moving away from the viewer. Such “scale” illumination patterns may be thematically well-suited for use in electronic gaming machines that have a theme involving fish (such as koi) or dragons, as such characters or animals have scales.

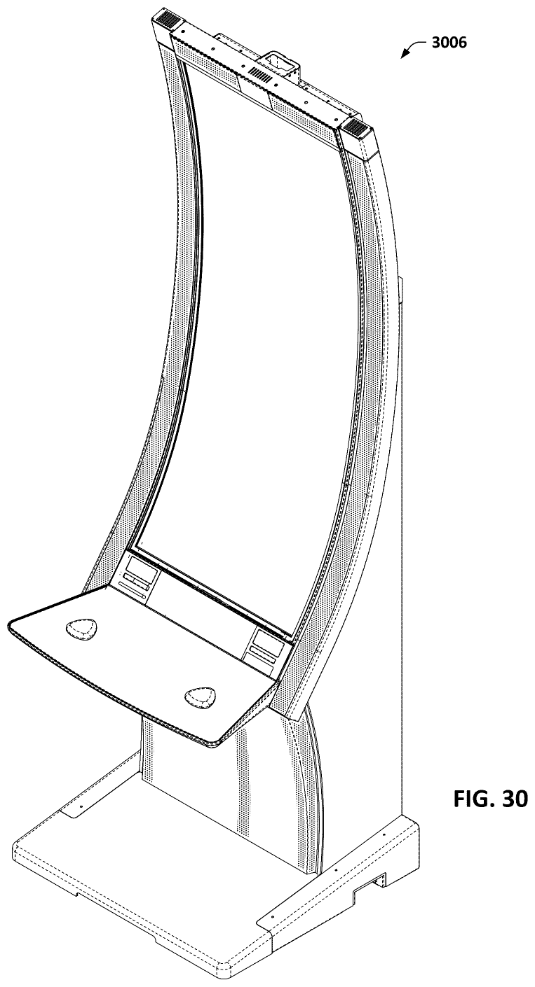

As discussed earlier, the lighting modules discussed herein may be used in a variety of contexts, but may be particularly well suited for use in electronic gaming machines. While not intended to be limiting, FIG. 30 depicts various locations 3006 that such lighting modules may be located in on an example electronic gaming machine cabinet 3000. However, it will be understood that such lighting modules may be used in a variety of other styles of electronic gaming machine cabinets and/or other equipment as well.

It is to be understood that the phrases “for each <item> of the one or more <items>,” “each <item> of the one or more <items>,” or the like, if used herein, are inclusive of both a single-item group and multiple-item groups, i.e., the phrase “for . . . each” is used in the sense that it is used in programming languages to refer to each item of whatever population of items is referenced. For example, if the population of items referenced is a single item, then “each” would refer to only that single item (despite the fact that dictionary definitions of “each” frequently define the term to refer to “every one of two or more things”) and would not imply that there must be at least two of those items.

The term “between,” as used herein and when used with a range of values, is to be understood, unless otherwise indicated, as being inclusive of the start and end values of that range. For example, between 1 and 5 is to be understood to be inclusive of the numbers 1, 2, 3, 4, and 5, not just the numbers 2, 3, and 4.

The use, if any, of ordinal indicators, e.g., (a), (b), (c) . . . or the like, in this disclosure and claims is to be understood as not conveying any particular order or sequence, except to the extent that such an order or sequence is explicitly indicated. For example, if there are three steps labeled (i), (ii), and (iii), it is to be understood that these steps may be performed in any order (or even concurrently, if not otherwise contraindicated) unless indicated otherwise. For example, if step (ii) involves the handling of an element that is created in step (i), then step (ii) may be viewed as happening at some point after step (i). Similarly, if step (i) involves the handling of an element that is created in step (ii), the reverse is to be understood. It is also to be understood that use of the ordinal indicator “first” herein, e.g., “a first item,” should not be read as suggesting, implicitly or inherently, that there is necessarily a “second” instance, e.g., “a second item.”

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

What is claimed is:

1. An apparatus comprising:
a first lenticular screen having a plurality of first lenticules extending along corresponding first paths;
a plurality of light sources; and
a housing that supports the first lenticular screen relative to the light sources, wherein:
the lenticular screen is separated from the light sources by at least a first distance, and
the first distance is at least 0.25 inches.

2. The apparatus of claim 1, wherein:
the light sources are arranged along one or more second paths, and
the light sources arranged along each second path are arranged along that second path in an evenly spaced manner.

3. The apparatus of claim 2, further comprising a controller, wherein the controller is configured to selectively control subsets of the light sources to cause progressive changes in one or both of color of light emitted by the light sources in each subset of the light sources and magnitude of light emitted by the light sources in each subset of the light sources along the second path or second paths.

4. The apparatus of claim 3, wherein the controller is, or is in communication with, an electronic gaming machine controller.

5. The apparatus of claim 2, wherein there are multiple second paths.

6. The apparatus of claim 5, wherein the second paths are identically shaped and oriented and spaced apart from one another along an axis.

7. The apparatus of claim 6, wherein the second paths each define a plane and the axis is perpendicular to the plane.

8. The apparatus of claim 1, wherein each first path is at a corresponding first oblique angle relative to a first edge of the first lenticular screen.

9. The apparatus of claim 8, wherein the first oblique angles are between 30° and 60°.

10. The apparatus of claim 1, wherein each first path is perpendicular or parallel to a first edge of the first lenticular screen.

11. The apparatus of claim 1, further comprising a first transparent layer, wherein the housing supports the first transparent layer such that the first lenticular screen is between the first transparent layer and the plurality of light sources.

12. The apparatus of claim 11, further comprising a second transparent layer, wherein the housing supports the second transparent layer such that the first lenticular screen is between the first transparent layer and the second transparent layer.

13. The apparatus of claim 12, wherein:
at least one of the first transparent layer and the second transparent layer supports the first lenticular screen, and
the housing supports the first lenticular screen by supporting the first transparent layer and the second transparent layer.

14. The apparatus of claim 1, further comprising a second lenticular screen, wherein:
the housing supports the second lenticular screen,
the first lenticular screen defines a first side portion of the apparatus,
the second lenticular screen defines a second side portion of the apparatus, and
the first side portion and the second side portion face in different directions.

15. The apparatus of claim 14, wherein:
the second lenticular screen has a plurality of second lenticules extending along corresponding second paths,
each first path is at a corresponding first angle relative to a first edge of the first lenticular screen,
each second path is at a corresponding second angle relative to a second edge of the second lenticular screen,
the first edge of the first lenticular screen is a closest edge of the first lenticular screen to the second edge of the second lenticular screen, and
the first angle is different from the second angle.

16. The apparatus of claim 15, wherein the first angle is an oblique angle and each second path is parallel or perpendicular to the second edge.

17. The apparatus of claim 1, further comprising a gaming machine cabinet, wherein the housing is mounted to the gaming machine cabinet.

18. The apparatus of claim 17, wherein the housing extends along one or more of a side edge of the gaming machine cabinet, a horizontal edge of the gaming machine cabinet, a curved edge of the gaming machine cabinet, and a curved surface of the gaming machine cabinet.

19. The apparatus of claim 1, further comprising a controller, wherein the controller is configured to selectively control proper subsets of the light sources to switch each light source in each proper subset of the light sources between two or more states, each state differing from the other state or states in terms of one or both of color of light emitted by that light source and magnitude of light emitted by that light source.

20. The apparatus of claim 19, wherein the controller is, or is in communication with, an electronic gaming machine controller.
